(19) United States
(12) Patent Application Publication
(10) Pub. No.: US 2013/0246392 A1
(43) Pub. Date: Sep. 19, 2013

(54) Conversational System and Method of Searching for Information

(71) Applicant: INAGO INC., Tokyo (JP)

(72) Inventors: Gary Farmaner, Toronto (CA); Ron DiCarlantonio, Tokyo (JP)

(73) Assignee: INAGO INC., Tokyo (JP)

(21) Appl. No.: 13/758,449

(22) Filed: Feb. 4, 2013

Related U.S. Application Data
(60) Provisional application No. 61/610,606, filed on Mar. 14, 2012.

(51) Int. Cl. G06F 17/30

(52) U.S. Cl. CPC G06F 17/30442
USPC 707/713; 707/769; 707/722

(57) ABSTRACT

A system and method for performing an operation based on a contextual command, which operation further comprises interactively searching for information, comprising: receiving an input in a context, returning a result in respect of the received context by at least one of reducing, relaxing, and location handling in respect of the input value, and performing an operation based upon the context of the input criteria. Reducing comprises narrowing the total number of results by their contextual relevance, wherein the narrowing is comprised in dynamically generated real-time interactions. Relaxing further comprises, when an exact result is not found, broadening the input search criteria automatically, and where appropriate, obtaining a result. The location handling further comprises disambiguating addresses and locations where there are conflicts based on an input history, and establishing relationships within addresses based upon the input history.

### PRIORITY

This invention claims priority from U.S. Provisional Application 61/610,606 filed on Mar. 14, 2012. U.S. Provisional Application 61/610,606 is included herein in its entirety by reference.

### BACKGROUND

1. Field

Embodiments of the invention relate generally to searching via computers and computer applications, and more specifically to voice based, contextual, conversational and interactive search on network enabled computer devices, but more specifically network enabled mobile communicating computer devices, generally on the internet, but also on the device itself.

2. Related Art

There are two common forms of searching for information today; keyword driven search or call flow driven search.

Keyword driven search allows the user to search a large amount of data by inputting a search phrase either as a list of keywords or in some cases a natural language sentence and obtaining a list of highly likely related information. The problem with this method is that the user is challenged with having to pick the perfect search phrase to get the exact information they are looking for. Typically a very large list of information is provided to the user in a returned result and the user must decide herself how to adjust the search query to reduce this list of information to get the results they are interested in. Very little assistance is provided to the user for reducing this list to their needs, other than, for example, the seldom and well known (say) “Did you mean Jaguar?”

Call Flow Driven Search allows the user to search for information through a pre-defined list of options. An example of this would be an automated phone system where the user is presented with a list of options to choose from and wherein the user cannot move forward without selecting an appropriate option from the list of presented options. Another example would be a website which allows users to select specific pre-defined categories to narrow their search results. This method provides an interactive method for finding information, which is easy to use. The problem with this method is that the user can typically only provide one piece of information at a time and must follow a specific pre-designed flow of questions regardless of their needs. An additional serious problem is the time required to develop and maintain an effective call flow that is both easy to use for the user and covers the data being searched sufficiently. Since the data itself is changing based on the user location, their needs, and the databases being searched, a pre-designed call flow does not provide an efficient method (least amount of steps) to reach the desired results. Further, call flow driven searches are passive from the user's perspective, wherein the user is asked to follow directions in order to obtain relevant information. Call flow driven searches are not equipped to be able to dynamically follow instructions from a user, and search according to user's preferences.

Natural language and keyword search often leads to too many search results, and users must continue to add keywords themselves to find what they are looking for. Interactive, intelligent chat systems developed to address the aforementioned challenges need to be “authored” such that questions and scenarios were written specifically for each type (or Domain) of content, and context, presenting a huge development hurdle, in terms of time, effort and cost. Essentially every type of domain, content, and context needs to be anticipated in authoring such chat systems. There is thus a need for an intelligent system and method that allows itself to automatically determine which questions to ask such that the results could be narrowed to the user's specific needs, based on content, context, etc. Essentially, a system that can process user input queries and calculate responses as well as counter queries is highly desirable.

There remains a need for intelligent, context aware systems and methods wherein context awareness is automatic, based upon user input type, and provokes performance of an operation based on the determined context awareness. Additionally, there remains a need for systems and methods that allow contextual understanding of user input for effective and accurate searching of relevant information. There remains a further need for automatic and pro-active context awareness, wherein user input in a context provokes a system to in turn respond as well as counter question the user in a manner that aids in narrowing down generic queries to specific ones that lead to obtaining a relevant result.

Embodiments disclosed address the above drawbacks.

### SUMMARY

Embodiments disclosed recite systems and methods for performing an operation or operations, based on contextual commands, which operations further comprise interactively searching for information wherein the system asks key questions to lead the user to the desired results in as few steps as possible. The system comprises a first computing device (including, but not limited to, personal computers, servers, portable wireless devices, cellular phones, smart phones, PDA's, video game systems, tablets, smart televisions, internet televisions, and any other specialized devices that comprise computing capability), and narrows down what the user is asking for through follow-up questions and answers wherein a search query is transformed into an interactive list of choices resulting in a short list of appropriate results. Preferred embodiments include voice recognition, and also wherein the system simulates a human conversation, receiving voice commands, interacting in context and pro-actively asking appropriate questions to disambiguate the user's original request and obtain the user specific desire to find appropriate results. Alternate embodiments include systems which may receive text input and respond textually, receive text input and respond with voice based output, and receive voice input and respond textually. Other variations are possible as would be apparent to a person having ordinary skill in the art.

Embodiments disclosed include a computer automated system for interactively searching for information, comprising a processing unit and a memory element, and having instructions encoded thereon, which instructions cause the system to: receive a voice input command which corresponds to a search that can be performed in a context; return in response to the voice input command in the context at least one of a search result and an interactive list of relevant choices; if an interactive list of relevant choices is returned, receive a voice input selection of at least one of the returned choices; and wherein the relevant choices are comprised in dynamically generated real-time interactions based on the input voice commands.

Embodiments disclosed include a method for interactively searching for information, comprising: receiving a voice input command which corresponds to a search that can be performed in a context; returning in response to the voice input command in the context at least one of a search result and an interactive list of relevant choices; if an interactive list of relevant choices is returned, receiving a voice input selection of at least one of the returned choices; and wherein the relevant choices are comprised in dynamically generated real-time interactions based on the input voice commands.

### BRIEF DESCRIPTION OF DRAWINGS

FIG. 1 illustrates a process flow in an embodiment of a system that enables searching for content & information through Conversational Interaction.

FIG. 2 illustrates the process flow in an embodiment, of the reduction method.

FIG. 3 illustrates the process flow in an embodiment, of the relaxation method.

FIG. 4 illustrates essential components of the system in an embodiment.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Natural Language—A human language, in contrast to a formal (i.e. specifically designed) language (like a computer programming language). In the modern online world, natural language is affected by issues of spelling, grammar, colloquialisms, slang, abbreviations, emoticons, swearing, technical terms, acronyms, etc.

Natural Language Processing (NLP)—The conversion of a string in a natural language into a data structure, or formal language, that provides information about the string. This can include work tokenization, morphological analysis (e.g. parts of speech), and dialogue act (type of sentence), and general conversions of the input into a form more suitable for computation manipulation.

Natural Language Understanding (NLU)—A set of algorithms used to map an input in a natural language to a set of system state changes that reflect the affect the input is intended to achieve.

Agent—A system capable of interaction using natural language, in an intelligent way, for a useful purpose.

Conversational Interaction—The set of inputs and outputs between the user and the Agent.

Smalltalk—Simple responses to user input meant to make the experience more enjoyable, and provide personality to the Agent.

Queries—Information requests on the current search candidate set that does not change the current search conditions (for example: How far is this store from me?)

Domain—The subject or subjects the Agent is prepared to interact about.

Locale—The set of attributes related to the user's current location. This can include position/location, default language, measurement units, date and time formats, etc.

Synonyms—Words or phrases which have a common meaning in the domain of operation.

Normal—A canonical name representing a set of Synonyms

Family—A formal collection of related Normals.

Genre—A placeholder that represents a hierarchical family of related words. In one embodiment it consists of the combination of a Family and a Normal.

Genre Tagging or Input Genre—A representation of a word or sub-sentence of the input by a Genre with the attached word or sub-sentence.

Genrization—The process of Genre Tagging a string.

Genrized or Genre Tagged—Having had Genrization applied.

Genre Condition—A list of words and Genres that can be matched in any order.

Genre Grammar Condition—A sentence or sub-sentence consisting of words, Genres, and special meaning grammar tokens. It is matched against genrized input to perform the NLU.

Matching Genre—Any specific Genre in the Genre Condition or Genre Grammar Condition

Genre Condition Match—The matching of the Genrized form of the user input with a Genre Condition or Genre Grammar Condition.

Key Genre—those Genres of a Genre Condition that are needed for the system to extract values for the target(s) of the NLU.

Associated Genre—Genres that if present should be considered to be also part of Genre Condition Match.

Criteria—A set of formally defined conditions represented via set of names, a sub-set of which can have one or more values applied for purposes of searching and/or controlling process flow. For ease of writing Criteria can refer to the singular in addition to the more grammatically correct plural.

Criteria Value—A single value for particular Criteria. Could be formalized (a canonical set of values) or “free input” meaning it takes on a value from user input or searched content (e.g. Store Name)

Collapsible or Drill-down Criteria—A Criteria who's Criteria Values are defined as a tree where the values become more specific the deeper in the value tree they appear. Collapsible Criteria are presented as lists flattened at a given tree depth, and can have the children presented (drill-down) to further restrict the value.

Area Criteria—Criteria that holds a value that has a meaning specifically related to a location (a single GPS point, such as a landmark) or a bounded region (a neighborhood, city, etc.)

Ancestor Value—In a Collapsible Criteria, an Ancestor Value is one that is in the direct ancestor path of a given value (i.e. is a parent, grandparent, etc.)

Descendant Value—In a Collapsible Criteria, a Descendant Value is one that is in a direct descendant path of a given value (i.e. is a child, grandchild, etc.)

Criteria Condition—A Boolean expression on the state of current Criteria, where valued, not valued, specifically valued, ancestor and descendant valued can be expressed.

Context—An identifiable state of the system. Includes the domain of search, Criteria, Data Fields, GUI state, Agent mode, user's locale, user's profile and the interaction between the user/client application and system/Agent including what the user has said and the Agent has responded (Conversation Context).

Active Context—The current system context.

Context List—A representation of current and past Active Context where the Active Context is considered to be highest priority. The list constitutes a context history where the past contexts can age (become less relevant) and die (be removed from the list and hence become irrelevant).

Conversation Context—A specific type of context which refers to the state related to what the user or agent has said. There is an implied history to the Conversation Context (the past affects the future).

Relevant Context—A matching context condition that is appropriate (relevant) to the current Active Context.

Resulting Context—The context the system changes to or remains in due to processing of some input.

Reduction—The process of reducing the number of active candidates of a search. This could include obtaining new conditions that restrict the search space, or more restrictive values of current conditions.

Relaxation—The process of relaxing the current conditions to allow more active candidates of a search. This could include deleting one or more conditions or replacing one or more with less restrictive values.

System Process Commands—A set of formal actions that change the state of the current system.

Genre Mapping—An NLU technique which maps Genre Tagged user input (or simulated user input) to System Process Commands.

Disambiguate—Disambiguate meaning—Refers to the act of resolving an ambiguity between two or more possible interpretations of user input, such as requesting the user to choose a particular interpretation when the system is unable to determine the proper one among several ambiguous choices (e.g. which city “Richmond” is intended), or the system using additional information, such as context, to automatically choose the best interpretation. Disambiguate intent can refer to the act of Reduction (the active search candidates are considered the ambiguity).

The present embodiments disclose techniques which enable the design and processing of a variety of systems and methods for enabling conversational input textually, in voice, or a combination of both. Embodiments disclosed enable context aware interactive searching and an enhanced user experience, improving usability by guiding the user to desired results by pro-actively presenting in response to user input, contextually relevant questions when there are too many results/responses returned from a user input query. The contextually relevant questions will guide the user to know what kind of information they can provide to find more appropriate content for them (i.e. reduce the list of results). Embodiments include programs that determine the best question to ask to reduce the set of results and ultimately reduce the number of question-answer steps to a short list of results. Embodiments disclosed allow for a shortened development time as the system and method is designed to determine the prompts for information to present to the user, including questions to ask the user, based on the context of user input. Rather than being pre-authored the appropriate information for which to prompt, including questions to ask will be dynamically, programmatically calculated/determined based on the current content domain, context and available search results.

Context Aware Interactive Search (CAIS)—Embodiments disclosed include a method and system for performing a context aware interactive search, comprising: receiving an input of a data item in a first context; performing an operation in the context of the received input; reducing a set of results obtained by programmatically determining and returning context relevant questions, or by disambiguating the user input (what the user has said) to find the most appropriate short list of results for a specific user input (request). In a preferred embodiment, context includes: a. Criteria, b. Agent or System state, and c. Conversation context. Criteria further comprise normalized values for search criteria determined by the system, from the user, through free input and interaction of the user with the system. Agent (system) state comprises the contextual relevance of a returned result by the system in response to user input (a list, details, map, route, etc.). Conversation context comprises context in respect of the interaction already occurred between the user and the Agent (System). The system comprises a processing unit coupled with a memory element, and having instructions encoded thereon wherein the instructions further allow and cause the system to: recognize context by its relevance, and further to calculate relevance by most recent use. In an embodiment, the system is caused to list active context in most recently used order and the instructions will cause the system to consider the first listed context as the most relevant. In such embodiments relevance of conversational context changes frequently, and can become less relevant (i.e. ages and dies) over time.

Preferred embodiments recognize general context by its relevance. For example, in respect of user input that returns a set of ambiguous matches, the most relevant context is the context in which the input was most recently used. And thus that most recently used context is applied in returning a result. So, for a set of ambiguous matches, that associated with the most recent context would win. Context can also include settings such as user preferences, user location, and user language. Further, conversational context is also recognized in a user interaction and the recognition evolves as the conversation progresses. An embodiment accomplishes contextual relevance by maintaining a priority list (descending order of priority) of conversation contexts (a conversation context list or CC List); each with an attribute of some abstract time the context was visited, and uses a pop to front methodology. For example the abstract time could be actual time, or an interaction number. A conversation context Cn(t)—Where n is the context number and t is its time attribute. For example, say there are three conversation contexts C1, C2, and C3. Let's say Conversation contexts C1, C2, and C3 are first visited in order, one after the other. We'll use interaction number as our “time” attribute.

### CCList1: C1(1)

### CCList2: C2(2), C1(1)

### CCList3: C3(3), C2(2), C1(1)

As shown above, C3 is more relevant than C2, which in turn is more relevant than C1. However, if Context C1 is revisited, then C1 regains the highest relevance, and is caused to pop back to the front. Thus, we will have CCList4: C1(4), C3(3), C2(2).
Death of contexts: Context death is definable wherein, for example, a context can be caused to die when it reaches the end of a queue. The length of a queue can also be defined, wherein the system is programmed to dynamically define a queue based on usage and other variables, or wherein the queue is fixed, and defined by the content developer. Using a fixed list queue length, and/or explicit aging and a context lifetime wherein for example in a fixed length of three, C4 is visited. Thus we have CCList5: C4(5), C1(4), C3(3) which cause C2 to fall off the end of the queue and die. Essentially (say) the system is pre-programmed to keep contexts alive only for three interactions. So, when we revisit C1, and then C4, we have

### CCList6: C1(6), C4(5), C3(3)

### CCList7: C4(7), C1(6)

C3 dies because the current time 7 minus C3's time 3 is greater than 3
The above example is for illustrative purposes only. In practice, the list length is likely to be much longer than 3 and the lifetime of the contexts may be varied depending on the nature of the contexts. Additional modifications are possible as would be apparent to a person having ordinary skill in the art.

An embodiment includes a computer automated system and method for development of a dynamic, continuously evolving interactive capability. The system and method are comprised in a Hybrid Automated & Rule-based Agent/System comprising a processing unit and memory element, and having instructions encoded thereon, which instructions cause the system to develop evolving interactive agent (system) capability without having to author scenarios for each user interaction (i.e. essentially allowing a developer to create an intelligent, automated interaction system which determines an interaction based on the context and content). The instructions further cause the system to define rules to enhance the automated functionality and to implement Natural Language Processing (NLP) which comprises mapping of user input to meaning. Natural Language processing further comprises “Genre Tagging” which includes matching of words and phrases of user input to a normalized semantic form for comparison with content. The said “Genre Tagging” further comprises using (analyzing) parts of speech from a morphological analyzer to address ambiguous Genre Tagging. For example, the system could differentiate between “set” the noun and “set” the verb. Additionally, the encoded instructions cause the system to create a hierarchical structure for allowing matching to more and more general ancestors. Additionally and alternatively, Natural Language Processing further comprises automatic conversion of a string in a natural language to a structured form which provides a basis for determining meaning (semantics). Some prior art techniques include: Word Tokenization, implemented for languages like Chinese and Japanese, for example, which don't have space separation for words; Morphological analysis, which entails determining parts of speech, i.e. verb, noun, adverb, etc. and Dialogue Act, which is an indicator of the nature of the sentence as a whole (question about location, statement of desire, etc.) In a preferred embodiment, NLP extends these techniques to comprise processing based on context, and Genre Tagging.

Simple string representation for easy matching to content—A Genre is a representation of a semantic concept consisting of three parts: (a) A normal, which is a canonical (normalized) representation of a potentially large set of synonyms/phrases/sentence fragments (perhaps in multiple languages), (b) A family, which is a grouping of associated normals, and (c) The raw word or phrase from user input associated with the Genre. This could be represented by a data structure, or a string. For purposes of simplicity, we will represent the form as the string of the form Normal_Family_Raw. Content can define a set of words and phrases that are to represent the semantic concept of a particular Normal_Family. For example:

Italy_Cuisine=Italian cuisine, Italian food, some food from Italy, Italian
Fivestar_Rating=five star, 5 star, the best
Remove_Action=delete, remove, eliminate, take away
The system will then replace user input with a form which contains Genres. This we refer to as “Genre Tagging”, or simply “tagging”.
User input: The best Italian food
Tagging: FiveStar_Rating_the %20best
Italy_Cuisine_Italian %20food The raw user input is thus tagged with associated Genres
To make things easier to read, let's leave off the raw user input part

### Tagging: Italy_Cuisine FiveStar_Rating

Dynamic normalization. There are extremely useful families where the set of possible normals is too large to be feasible to define in content, such as Numbers, Time, Date, etc. For example, it would be very useful to deal with time in the following manner: If the user inputs a time, it can be placed in the Criteria titled StartTime. This can be accomplished by defining a Genre Mapping rule that uses the Family of a dynamically normalized Genre: _Time→Set a StartTime criteria to the value associated with the Normal. Dynamic normalization refers to the ability to dynamically (at run-time) create the Normal for the Genre. Example: User input: 1:32 pm; Tagged form: T1332_Time; The T1332 is a dynamically created normal.

This is accomplished by defining a Matching Grammar that matches the user input, captures information in that input, and then passes that information to a specific conversion routine (potentially content defined) to create the Normal from the captured data.
Then the content developer can define a Genre Mapping rule for dealing with all-time input:

### Matching Condition: _Time

Operation: Set the StartTime criteria to the value associated with the Normal of _Time. For example T1332→StartTime=13:32

Genre Mapping—Genre Mapping is a natural language understanding (NLU) method of mapping the Genre Tagged form of user input (syntax) to rules for handling that input (semantics). The system matches the user input against Genre Mapping rules, and consumes the associated parts of the tagged input as the rules are applied. A single Genre Mapping rule definition consists of:
A matching condition, which is either a Boolean expression of Matching Genre, wherein associated with this is an optional list of key Matching Genre for purposes of applying the operation, or a Matching Grammar. Key Matching Genre is that Genre of the Matching Genre expression that is used to extract information, specifically the Normal.
Optional relevant contexts such as a Boolean expression of currently defined criteria, Agent/System state (e.g. showing a map, showing details, etc.), conversation context, user preferences, locale, language, etc.
One or more operations to perform—Example: Set criteria, add to criteria, delete a value, present a list of values of criteria, send an email, show a map, output a message, etc.
Associated Genres—Other Genres that if present represent the same semantics, and should be consumed with the processing of the Genre Mapping.
   Matching Genre forms are a representation of Genre for purposes of matching to Genre Tagged representations of input. They consist of: (a) An optional normal, (b) The family, or (c) A raw keyword representation. For example, we can represent these as Normal_Family or _Family (any normal of the family) and Raw (specific keyword match).
   Normal_Family_Raw matches to Normal_Family
   Normal_Family_Raw matches to _Family
   Normal_Family_Raw matches to Raw

### Boolean Expression of Matching Genre

This is a Boolean expression of Matching Genre and allows complicated matches against the user input. Given Matching Genres A, B and C, Boolean expressions such as these can be defined:
A—Matches if A occurs anywhere in the remaining user input
A and (B or C)—Would only match if remaining user input matches A and either/both B or C
A and not B—Would only match if remaining user input matches A but not B
   The orders the Genres appear in the user input versus the matching condition definition are not important, nor are the presence of intervening other Genres or keywords. Hence, a single rule can be written to handle both these user inputs:

### Example

Input: “remove Italian”

### Tagging: Remove_Action Italy_Cuisine

Input: “Italian, remove please”
Tagging: Italy_Cuisine Remove_Action (“please” removed as an unimportant word)
In cases the order is important, then a matching grammar is used instead of a matching condition.

### Boolean Expression of Currently Defined Criteria

This is a relevant context expression that is a Boolean expression on currently defined criteria. This allows content to define Genre Mappings that only match if certain criteria are defined or not defined. For example, for criteria X, Y and Z
X has a value and (Y has a value or Z has a value)
X has a particular value and Y is not a particular value

### Applying Genre Mapping Rules

An agent/system can define many Genre Mapping rules for handling user input in the particular domain of the agent. Content can be used to define a Genre Mapping rule wherein in response to user input for (say) a restaurant serving a particular cuisine, then a rule is executed which sets a search criterion of food type to the user input cuisine asked/searched for. Or (say) a user is looking for a local business of a particular type, the search criterion is set accordingly. For example, if Italy_Cuisine is input by the user, then a rule is executed which sets a search criterion Food Type to Italian. The following indicates the system response to user input:

### Matching Condition Italy_Cuisine

Operation: Set FoodType criterion to the FoodTypeValue Italian
An even more powerful abstraction is possible in that the Genre Mapping requests a match of the FAMILY Cuisine, then assigns the FoodType value associated with the normal. So in that case we have the following:

### Matching Condition: _Cuisine

Operation: Set FoodType criteria to the FoodTypeValue associated with the normal of the _Cuisine tagging of the user input.
Additionally, as Genre Mapping matches rules and processes them, it removes the taggings that were matched, and then continues to see if there are other rules to apply.
Initial tagging: Italy_Cuisine FiveStar_Rating

### Matching Condition: _Cuisine

Operation: Set FoodType criteria to the FoodTypeValue associated with the normal of the _Cuisine tagging of the user input.

### Result: Cuisine=Italian

Remaining tagging: FiveStar_Rating

### Matching Condition: _Rating

Operation:→Set RatingLevel criteria to the RatingLevelValue associated with the Normal of the Genre matching _Rating.

### Result: RatingLevel=5

Remaining tagging: none
Also, if the user were to say multiple instances of the same Genre, these would also be automatically handled:
Input: “Italian or pizza”

### Initial Tagging Italy_Cuisine Or_Relation Pizza_Cuisine

### Matching Condition: _Cuisine

Operation: Set FoodType criteria to the FoodTypeValues associated with the normal of the _Cuisine tagging of the user input.

### Result: FoodType=Italian or Pizza

### Matching Grammar

Another possible form of a Matching Condition is a grammar. This is a sentence or sentence fragment using Matching Genre forms that is matched against currently remaining user input, and must match fully and in order.

### Tagging: Remove_Action Italy_Cuisine Add_Action France_Cuisine

Note that a simple Matching Condition would lead to wrong behavior:
Initial tagging: Remove_Action Italy_Cuisine Add_Action France_Cuisine

### Matching Condition: Add_Action _Cuisine

Operation: Set FoodType criteria to the FoodTypeValues associated with the Normal of the _Cuisine tagging of the user input.

### Result: FoodType=Italian or French

But, we can define grammars:
Initial context: FoodType=Italian

### Matching Grammar: “Remove_Action _Cuisine”

Operation: Remove FoodTypeValue associated with the Normal of the _Cuisine from the Food
Result: FoodType=<none>

### Matching Grammar: “Add_Action _Cuisine”

Operation: Set FoodType criteria to the FoodTypeValues associated with the Normal of the _Cuisine tagging of the user input.

### Result: FoodType=French

Fixed Data Schema simplifying content access to mashups—an ideal embodiment of the Automated & Rule-based Agent/System comprises a standard protocol called NPCQL (NetPeople Content Query Language) which defines a method for querying and obtaining results from a Content Provider optimized for the context aware interactive search. Preferably, NPCQL is designed such that there is no dependency on any one API or content provider and comprises means to separate specific Content Provider API calls from specific requests and results returned, as described in the disclosed embodiments. NPCQL allows the agent/system to access 3^{rd} party content without any dependency on the content provider itself. Thus content providers can be changed and added (“mashed up”) without any changes required to the agent/system. Alternatively, 3^{rd} parties can integrate with the system by simply supporting the NPCQL protocol. Additionally, NPCQL comprises defined data schema for each content Domain. For example, Restaurant search will have a schema for criteria and result data standard for restaurant search such as Food Type, Service Types, Budget, etc. This schema can be easily added to without affecting existing implementations. Schema used for specific Domains will incorporate generic data such as time and budget, with specific data such as Food Type.

Auto-disambiguation by learning. Preferred embodiments include encoded instructions which allow the system to learn in an automated fashion. For example, ambiguous things can be learned to be not ambiguous in a practical sense from user choices. Say a user input “Toronto”. The system now needs to determine whether the user meant Toronto, ON or Toronto, Ohio—If (say) 99.9% of people choose Toronto, ON, the system is programmed to consider the proper semantics of “Toronto” IS Toronto, ON and if the user intends to input Toronto, Ohio then they will naturally know that they need to be specific (i.e. they need to input Toronto, Ohio due to the learnt familiarity that most people will interpret an input of just Toronto to mean Toronto, ON. Alternatively, the system can recognize a user pattern, and based on input by an identified user, can understand (say) an input of “Toronto” to mean Toronto, Ohio. Additionally and alternatively, the system can perform auto-disambiguation based on domain (interaction subject), locale/location (where the user is), gender, language, etc. Auto-disambiguation can be based on many other parameters and on variations of the above mentioned parameters, as would be apparent to a person having ordinary skill in the art.

Preferred embodiments include a plurality of sub-systems interconnected with/to each other, and each specializing in a particular domain. Thus, many Agents/Systems with a domain of expertise can be queried by a single user input, and return a confidence level for the individual Agent's ability to handle the input. The full processing can then be passed to the best handler.

Multi-client support through data transformers—Preferred embodiments use data transformers to transform information for the user into the best display format for the target client device. Data transformers can be used for different clients (e.g. smart phone, tablet, TV, etc.), different domains (Restaurants, Local Businesses, Grocery Stores, etc.), different countries, etc. The existence of data transformers allow the agents to be generic to any device and content they are dealing with and yet provide the best display possible for the user. Specifically a data transformer will receive a request from NetPeople to format unformatted content data for a specific device in the specified context of the interaction. The request may contain information to assist in formatting such as the language, area, number of characters permitted, etc. For example, if a list of restaurants is being requested the raw NPCQL data would be provided to the transformer with the device type and context (amongst other relevant information) and the transformer would return a formatted list of restaurant items that can be sent directly to the targeted client for display.

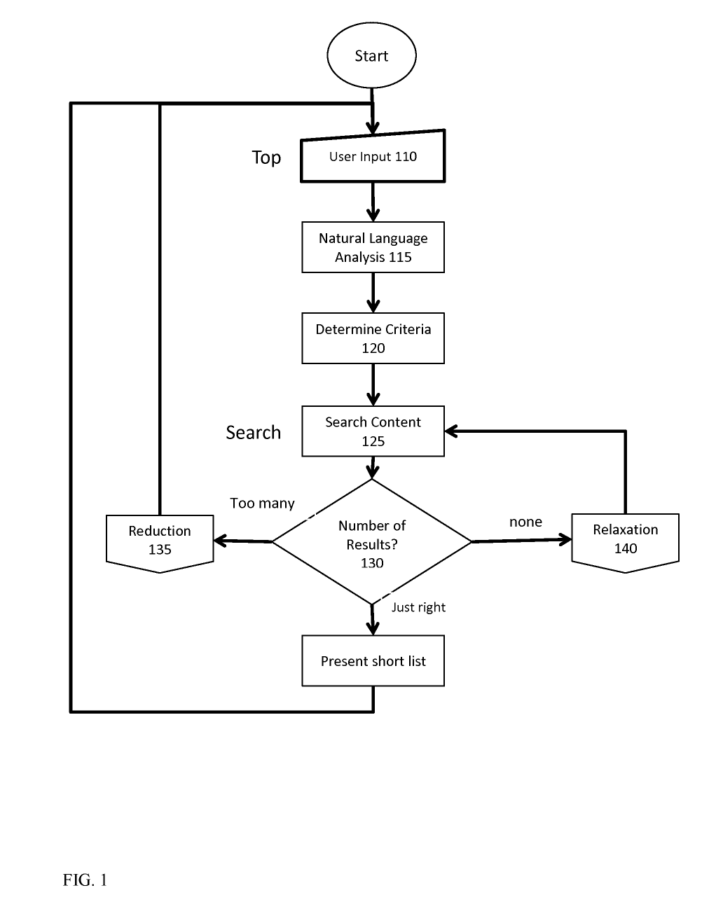

FIG. 1 illustrates a process flow in an embodiment of a system that enables searching for content & information through Conversational Interaction. Embodiments can facilitate voice based as well as textual conversational interaction, but preferred embodiments of NetPeople allow for voice based conversational interaction. In step 110, a user inputs a command, textually or by voice. Step 115 entails performing natural language analysis of the input command. Step 120 is determination of criteria. Step 125 involves searching for content based upon the determined criteria. Subsequently, in step 130, the system checks the number of results, and accordingly determines if reduction or relaxation is required. The reduction step 135 is implemented if too many results are returned and the user is asked to input more specific criteria. The relaxation step 140 takes place if no results are returned and a search is then performed based on broader, more generic criteria than that input by the user. Thus based on reduction or/and relaxation an automated search is performed and the most accurate results are presented to the user.

REDUCTION—If there are too many search results, which is a configurable value for the domain of the search, then the system is caused to “intelligently” ask the user for more information to determine what they really want, so that it can narrow, and thereby reduce the results to a short list. The system is caused to, dynamically and automatically choose the best criteria to ask the user based on the current search results, and presents a list of possible answers (criteria values) to help the user answer. For example, say a user is looking for restaurants in a particular area. The system may respond by asking (say) “What kind of cuisine are you looking for? Italian, Chinese, Vietnamese, Japanese . . . ” and so on. The system will determine which choices (criteria values) exist so that the user never makes a choice that ends in no results. Preferably the system will NOT automatically ask for Italian if there are no Italian restaurants in the results. Additionally, the system supports hierarchical criteria values to ensure that the lists of choices are always reasonable. If there are too many choices the system will look for the parents to create a narrowed, reasonable sized choice list. In an example embodiment, say the user is looking for a business. The user inputs a voice command that asks the system “search for a business in my location”. The system performs reduction and responds by asking “Which business category would you like? Bank, Government Office . . . ” and so on. The user responds by saying “Bank”. The system again performs reduction to work with specific criteria and asks “Local Bank, Trust Bank . . . ” and so on. Thus the system performs targeted, relevant searches that reduces by narrowing, and thereby in some instances eliminates searching for unnecessary, irrelevant items. However, there are cases where the content developer may want to control the criteria questions. The system comprises means for allowing Content Rules to be defined and taking priority over the automated system rules. Thus, based on log analytics, content rules and criteria are tuned to provide the most natural user experience. Variations and modifications of the above are possible, as would be apparent to a person having ordinary skill in the art.

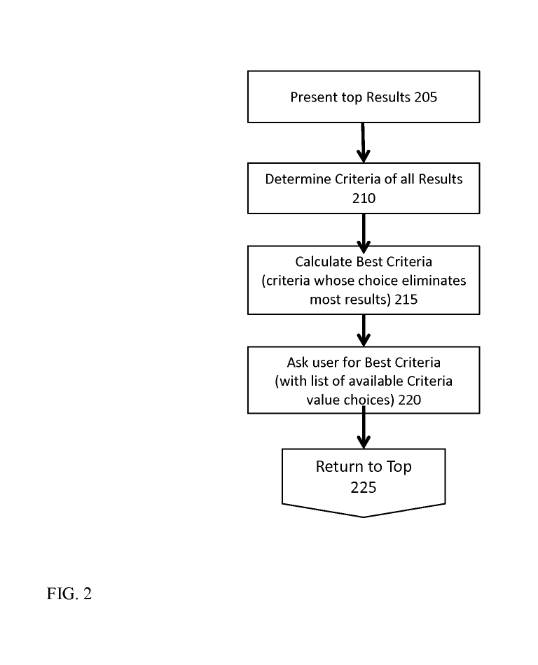

FIG. 2 illustrates the process flow of the reduction method in an embodiment. After a user has input search criteria, top results are presented in step 205. In 210 criteria of all the results presented are determined. In step 215 the best (most relevant) criteria is/are calculated, determined, and picked, wherein the calculation of the best criteria in preferred embodiments results in elimination of most results. Of the remaining (picked) criteria value choices the user is asked to select the best criteria in step 220. Subsequently, in step 225 the system returns with top results based on the reduced selection.

RELAXATION—When no search results are found then the system is caused to relax or broaden the criteria, automatically where appropriate. After relaxing the criteria, a search is performed and the system returns new search results. For example, say the user is looking for shops within a 1 kilometer radius of his or her current location, and there are none found in the search. The system will relax (broaden) the criteria, and will perform the search within a 2 kilometer radius (say) and return the following result: “I couldn't find any shops within 1 Km so I have expanded (broadened) to 2 km and found 5 shops. Here they are!” Relaxation rules are defined in content where appropriate. The following are some of the relaxation rules:

### Restaurant

If the user sets the “service” criteria, the system will try to remove it and re-search.
If the proximity is used then the system will try to expand the proximity.

### Local Business

If the user defines a special shop/place name and the merchant type, the system will try to remove the merchant type and re-search.

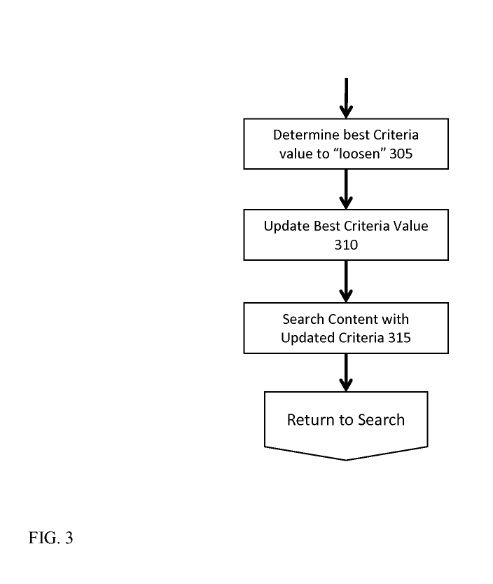

FIG. 3 illustrates the process flow of the relaxation method in an embodiment. After a search based on user input criteria yields no results, the system determines which of the user input criteria to broaden (loosen up) in step 305. The search is then performed again with the determined best criteria value to broaden (loosen), broadened (loosened) in step 310. Subsequently in step 315, results of the search performed with broadened (loosened) criteria values, are returned and presented to the user.

Area, Location disambiguation—The system further comprises instructions that cause it to recognize address information, locations, landmarks and Station Names. Preferably, the system further comprises means to disambiguate addresses and locations when there are conflicts. For example, if a user enters “Oakland” for a search the system can revert with “Did you want Oakland, Calif. or Oakland County, Michigan?” A preferred embodiment system can “understand” the parent-child relationships within addresses (neighborhood to city to state to country), and uses common ancestor (parent, grandparent, etc.) entities to aid in the disambiguation, so that if, for example, the user says “Oakland” and the user is in San Francisco (as determined from a reverse geocode of their GPS coordinates), then the system understands it as Oakland, Calif., USA. via the relationship of a particular Oakland to California and the context of the user being in California and hence the most obvious intent of the user is their local meaning of “Oakland”. Another example would be a neighborhood “Chinatown” which has many incarnations in various places, but can be disambiguated by a common address with the user (e.g. in the same city). Thus, as shown above, a preferred embodiment system can “understand” the relationships within addresses, so that if the user says “San Francisco” then the system understands it as San Francisco, Calif., USA as determined from a reverse geocode of their GPS coordinates, and any other relevant criteria. Further, rules are tuned and added based on user log analytics to improve the user experience

Tentative Criteria Setting—Preferably, the system comprises instructions that allow it to set/add one or more criteria tentatively rather than absolutely, and then automatically remove the setting if the search returns no results. For example:

### Absolute Criteria Setting:

Set value Ambience=Fun

### Search

Show results (possible none)

### Tentative Criteria Setting:

Set value tentatively Ambience=Fun

### Search

Case 1: Zero search results—Remove Fun from Ambience and Search Again
Case 2: One or more search results—Tentative setting becomes Absolute setting
Show Results for both cases
Note, other context may have changed along with the tentative setting(s), so this is NOT the same thing as backing out the last set of changes. This is backing out only the sets that were marked as being tentative.

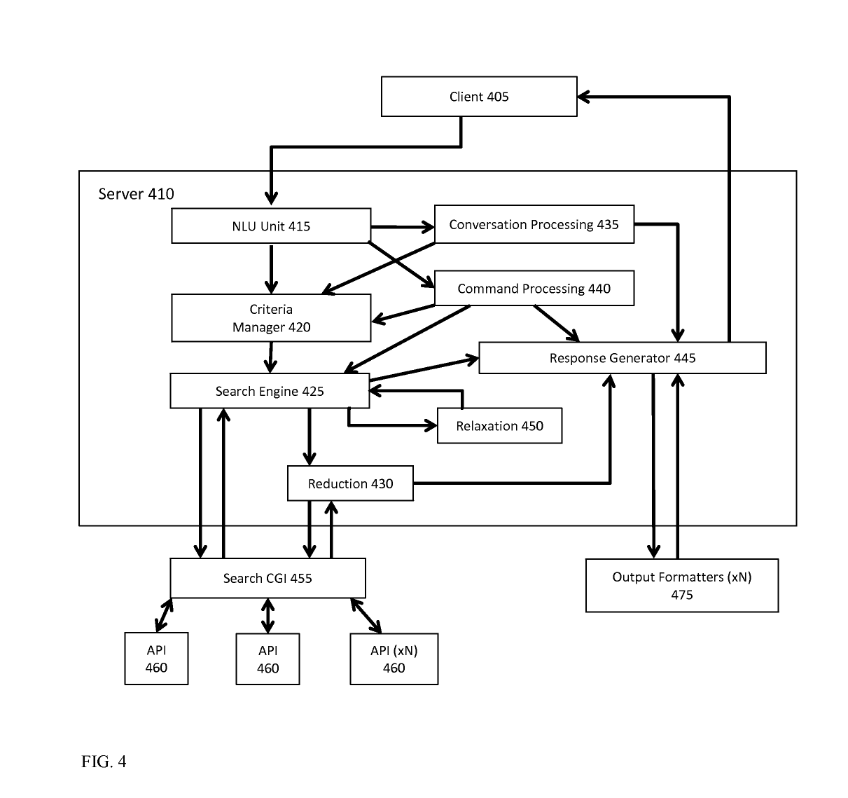

FIG. 4 illustrates essential components of the system in an embodiment. The Client 405 includes an application (app, web app, installed application, etc.) which provides an interface for the user to the system. It is capable of sending a textual, audio or visual input (derived from a keyboard, speech recognition, buttons, selection boxes, gestures, etc.) to the server 410 and receiving an output (text, text list, HTML, etc.) to display to the user. The Server 410, comprising a processing unit coupled with a memory element, and having instructions encoded thereon, further comprises a Natural Language Understanding Unit (NLU) 415, a Conversation Processing Unit 435, a Command Processing Unit 440, a Criteria Manager 420, a Search Engine 425, a Reduction Unit 430, a Relaxation Unit 450, and a Response Generator 445. The Natural Language Understanding Unit 415 is Capable of receiving a natural language text input from a human being, or an encoded representation of a command (from a GUI), and determining whether the input is a system process command (start over, go back), conversation, or a single/compound request to modify the current Criteria (search state). The Conversation Processing Unit 435 manages one (Smalltalk) or more (Conversation) input/prompt sequences which allow the system to provide simple answers, or a complex conversational interaction to answer questions, or determine a criteria change based on complex conditions. The Command Processing Unit 440 receives requests for process commands (go back, start over, etc.) which may change search state (back in history, start over), generate an interpretation of current results (details, map), or service a request of the client (go to a different domain, give me more results). The Criteria Manager 420 maintains the current search state of the system as well as a history. The Search Engine 425 generates a request on the external Search CGI based on the current state of the system. The Reduction Unit 430 is used when results count exceeds a configured target. It uses content defined and automatic mechanisms to prompt the user for inputting more specific criteria to narrow down the search and produce intelligent, relevant results. The Relaxation Unit 450 is used when no results are found. It allows for content defined and automatic mechanisms to adjust the search criteria in an attempt to find results (e.g. expand search radius). The Response Generator 445 combines search results.

The Search CGI 455 provides a virtualization of one or more external search APIs 460 in a consistent and standardized manner to the server. A single external data source can be queried using the specific application program interface (API). The Output Formatters take a standardized form of results, lists, etc. and generate an output for a particular domain, language, and client.

An embodiment includes a system comprising a processing unit coupled with a memory element, and having instructions encoded thereon, which instructions are written with minimal language dependencies. The few language dependencies are isolated into self-contained modules (DLL). The heuristics used are all designed to work no matter what the input or output language, or the locale. As such, extending support to new languages and territories is relatively simple, as would be apparent to a person having ordinary skill in the art.

In a preferred embodiment, the Natural Language Understanding Unit (NLU) can differentiate user input between small talk (simple query/response), conversational response (based on conversation context), control commands (user requests to specifically change the state of the app or system), content commands (e.g. requests to change search domain, show map, send related email/tweet etc., and list selection (textual/verbal input identifying a list item). Additionally, in preferred embodiments, the NLU can receive compound requests to change search state wherein content can be designed to manage simple change requests, which can then be input as a compound statement. For example, “I want cheap Italian near the airport” input by the user is handled by the system as separate requests based on “cheap” (cost), “Italian” (cuisine) and “airport” (search area).

Context as a founding principle—Context refers to: The current state of the system (e.g. mode), what is known (e.g. Criteria), and what has been said (Conversational context). In a preferred embodiment, the system can temporarily detour through a small talk or conversation and return to continue the main flow. Example:
i. Agent: What type of Cuisine would you like?
ii. User: What time is it?
iii. Agent: It is currently 2:30 pm.
iv. (optional) Agent: What type of Cuisine would you like?
v. User: What kind of Cuisine can I choose?
vi. Agent: The list shows the currently available. You can select from the list, or just say one of them.
vii. User: OK Italian

Union and intersection criteria—In a preferred embodiment, the system is capable of searching multiple values for specific criteria as union or intersection. For example, if a user is searching for a restaurant that serves pizzas, but is also open to the idea of Buffalo wings (say), then the user can input a request such as “pizza or wings” wherein either result returned is good for the user (the union of the results for pizza and for wings). Alternatively and additionally, say the user is looking for a restaurant that serves burgers and steak, a request such as “burgers and steak” will return results of only those restaurants that serve both burgers and steak (the intersection of the results for burgers and for steak).

Excluding criteria—In a preferred embodiment, the system and method allows recognition of user input and search based on excluded criteria. For example, say a user is looking for a restaurant that serves Japanese food, but is particularly not interested in sushi. A request such as “Japanese but not sushi” will yield results of only those Japanese restaurants that don't serve sushi.

Reduction Processing—Given a large result set, the system can provide a “smart prompt” to the user for selecting alternate search criteria. A content guided approach in an embodiment allows—a domain content developer to guide the system based on current criteria and other context. In an automated system, the system can determine the best subsequent criteria to collect based on the distribution of results among all the remaining criteria—A list can be presented to users that only contain the items active given the current context (criteria etc.). For example, the available price levels for top-rated Italian restaurants on the waterfront. Restriction (replace a criteria value) as well as collection (get currently unvalued criteria) can be implemented. Some Criteria have a natural order that provides more to less or less to more restriction on results (e.g. search radius, minimum rating, and price levels). The system can prompt for one of these criteria, automatically restricting the presented list to those values that will result in a reduction in search candidates.

Relaxation Processing (opposite of Reduction Processing)—It's possible the user's choices will return no results. In such an instance, embodiments disclosed can relax criteria to expand the search results without eliminating important search criteria. In one embodiment, the relaxation occurs automatically wherein the system determines which criteria to relax and still obtain contextually relevant results. Alternatively, the relaxation may be content guided, either automatic or user aided wherein the user is asked to modify the content of their request in order to obtain a relevant result. A content guided approach enables a domain content developer to guide the system based on current criteria and other context; in an automated approach, the system is enabled to determine the best subsequent criteria to collect based on the distribution of results among all the remaining criteria; and a user aided approach analyses user queries and based on the queried values returns a list to the user(s) that only contain the items active given the current context (criteria etc.).

Standardized searches—A search schema (criteria and their values) are defined for each domain that are independent of language and any underlying search engine. External search CGI support access to one or more (mash-up) external search engines and return a result schema (result fields and their values) to the system.

Response Generator—Templates and external output formatters—System uses externally defined CGI that are capable of generating appropriate layout of such things as candidate lists, for a particular client target. The output of these formatters, as well as natural human text forms of criteria or result field values can be used in a set of standard output templates defined which can target multiple zones of a client GUI
i. Agent Says—Prompts and description of what is being presented or requested
ii. Status—The current search state
iii. Info—A list of candidates, details, map, etc.

Embodiments disclosed recite responding to user input by performing a context aware search and returning a result by reduction, relaxation, and location handling. Preferably, embodiments enable and allow a context awareness wherein an operation can further be performed, upon user selection, in a particular context. Ideal embodiments enable automatic context awareness, and performing an operation based on the context awareness. Additionally, embodiments can feature non-contextual objective, contextual and multiple contextual understanding of user input for effective and accurate searching of relevant information. Preferred embodiments include a reduction method of dynamically and automatically choosing the best criteria to ask the user based on the current search results in presenting a list of possible answers (criteria values) to help the user answer. Preferably, embodiments disclosed allow for relaxing the criteria automatically where appropriate, in order to get an approximate result when an exact answer/result is not found. Preferably, embodiments include disambiguating addresses and locations where there are conflicts and intelligently understanding relationships within addresses.

Embodiments disclosed solve the Keyword Driven Search method's problem of forcing the user to continuously and independently edit search phrases to narrow the results by allowing the user to provide search information in context and by guiding the user on the information that would be most useful to narrow down the search efficiently.

Embodiments disclosed solve the Call Flow Driven Search approach problem of forcing the user to follow a pre-defined flow by allowing the user to say anything at any time and understanding that information in the context of the situation (what the user has said before and the current information being searched). The Call Flow Driven Search approach problem of having to frequently update the flows is also solved because these interactions are dynamically generated based on the user's requests and the results of the current information being searched.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure or the scope of the accompanying claims.

1. A computer automated system adapted to interpret commands contextually, and comprising a processing unit and memory element having instructions encoded thereon, which cause the system to:
receive a user input command which corresponds to an instruction for performing an operation in a context;
disambiguate the input command;
perform the operation based on the disambiguated input command; and
return in response to the disambiguated input command, zero or more results.

2. The system of claim 1 wherein the instructions further cause the system to:
if zero results are obtained, broaden the user input criteria to cause the system to return one or more alternate results in an updated context;
if one or more results are obtained, return the one or more results in the input context; and
wherein the one or more results are comprised in dynamically generated real-time interactions based on the disambiguated input context or updated context, respectively.

3. The system of claim 1 wherein the instructions that cause the system to disambiguate the input commands further cause the system to disambiguate at least one of user input intent and user input meaning.

4. In the system of claim 3, to disambiguate user input intent further comprises reduction, wherein in a plurality of obtained results, the system is caused to narrow the total number of results by their contextual relevance;
wherein the said narrowing is comprised in the dynamically generated real-time interactions, which further comprise automatically calculated responses to the input commands to reduce the set of results and the number of steps.

5. The system of claim 3 wherein in disambiguating user input meaning, the encoded instructions further cause the system to:
in response to user input, return a single or plurality of system interpretations for user clarification of an ambiguous input.

6. The computer automated system of claim 1 wherein context includes at least one of:
a content domain, criteria, data fields, GUI state, system state, user's locale, user's profile and the interaction between the user application and system including user input and returned system response; and
wherein said criteria comprise normalized values for user intent criteria determined from free input and interaction with the system;
wherein said system state comprises contextual relevance of returned response to user input; and
wherein conversation context comprises content exchanged during real-time interaction with the system.

7. The system of claim 6, further comprising instructions that cause the system to: perform the operation, which further comprises searching multiple values for specific criteria as at least one of a union and an intersection.

8. The system of claim 6, further comprising instructions that cause the system to, in response to the input, perform the operation based on excluded criteria in said input, wherein said excluded criteria comprises inputting what not to look for.

9. The system of claim 6 further comprising instructions that cause the system to:
in respect of a disambiguated input context, determine most relevant criteria to collect based on the distribution of results;
return a single or plurality of determined criteria collected, for user selection; and
narrow the returned result by contextual relevance, wherein the narrowing comprises analysing obtained results in the real time interaction, and returning one or more results comprising items active given the current context of the input criteria.

10. The system of claim 1 further comprising instructions that cause the system to:
in response to a result returned from a user input in a first context, receive an input in an unrelated context, and in response to said unrelated context, temporarily detour away from the said first context;
return a result in respect of the said unrelated context; and
revert back to the said first context;
wherein context comprises the current state of the system.

11. The system of claim 1 wherein the instructions further cause the system to obtain contextually relevant results, which comprises:
automatically broadening input criteria when zero results are obtained;
determining by analyzing the results obtained based on broadened input criteria, the most relevant results to collect, which determining is based on the distribution of results among active, broadened criteria; and
returning one or more determined, relevant results.

12. The system of claim 11 wherein the analyzing further comprises:
mapping a user input to meaning which comprises matching words and phrases of the input command to a normalized semantic form for comparison with the content;
creating a hierarchical structure for allowing matching of the input command to at least one of general ancestors and descendants; and
converting a string in natural language into a structured format for determining meaning semantics.

13. The system of claim 1 further comprising instructions to create a normal for a genre that the input content belongs to, wherein creating the normal comprises:
defining a matching grammar that matches the input command;
capturing information in that input; and
passing the captured information to a specific conversion routine to create the normal from the captured data;
wherein the conversion routine is content defined.

14. The system of claim 13 further comprising instructions that cause the system to:
implement genre mapping, which comprises matching user input against genre mapping rules, wherein any tagged input is consumed as the rules are applied.

15. The system of claim 1 further comprising instructions which cause the system to, in response to the input command, query and obtain results from a content provider optimized for a context aware interactive search.

16. The system of claim 1 further comprising instructions which cause the system to, in response to the input command, request an external system to perform an operation based on criteria obtained from a context aware interaction.

17. In a computer automated system adapted to interpret commands contextually, and comprising a processing unit and memory element having instructions encoded thereon, a method comprising:
receiving a user input command which corresponds to an instruction for performing an operation in a context;
disambiguating the input command;
performing the operation based on the disambiguated input command; and
returning in response to the disambiguated input command, zero or more results.

18. The method of claim 17 further comprising:
if zero results are obtained, broadening the user input criteria to cause the system to return a single or plurality of alternate results in an updated context;
if one or more results are obtained, returning the one or more results in the input context; and
wherein the one or more results are comprised in dynamically generated real-time interactions based on the disambiguated input context or updated context, respectively.

19. The method of claim 17 wherein disambiguating the input commands comprises causing the system to disambiguate at least one of user input intent and user input meaning.

20. The method of claim 19 wherein disambiguating user input intent further comprises:
reduction, wherein in a plurality of obtained results, narrowing the total number of results by their contextual relevance;
wherein the said narrowing is comprised in the dynamically generated real-time interactions, which further comprise automatically calculating responses to the input commands to reduce the set of results and the number of steps.

21. The system of claim 19 wherein disambiguating user input meaning comprises:
in response to user input, returning a single or plurality of system interpretations for user clarification of an ambiguous input.

22. The method of claim 17 further comprising:
determining context which comprises normalizing values for input criteria which values are determined from real-time user input;
determining system state based on results returned in response to user input; and
determining conversation context based on content exchanged during real-time user interaction; and
wherein the said context includes at least one of a content domain, criteria, data fields, a GUI state, system state, user's locale, user's profile and the interaction between the user application and system including user input and returned system response.

23. The method of claim 22 further comprising, performing an operation comprising searching multiple values for specific criteria as at least one of a union and an intersection.

24. The method of claim 22 further comprising allowing the system to, in response to the input, performing an operation based on input excluded criteria.

25. The method of claim 22 further comprising:
in respect of a disambiguated input context, determining most relevant criteria to collect based on the distribution of results;
returning a single or plurality of determined criteria collected, for user selection; and
narrowing the returned result by contextual relevance, wherein the narrowing comprises analysing obtained results in the real time interaction, and returning one or more results comprising items active given the current context of the input criteria.

26. The method of claim 17 further comprising analyzing context and content of user input wherein the analyzing comprises:
mapping a user input to meaning which comprises matching words and phrases of the input command to a normalized semantic form for comparison with the content;
creating a hierarchical structure for allowing matching of the input command to at least one of a single or plurality of general ancestors and a single of plurality of descendants; and
converting a string in natural language into a structured format for determining meaning semantics.

27. The method of claim 17 further comprising creating a normal for a genre that the input content belongs to, wherein creating the normal comprises:
defining a matching grammar that matches the input command;
capturing information in that input; and
passing the captured information to a specific conversion routine to create the normal from the captured data;
wherein the conversion routine is content defined.

28. The method of claim 24 further comprising instructions that cause the system to:
implement genre mapping, which comprises matching user input against genre mapping rules, wherein any tagged input is consumed as the rules are applied.

29. The method of claim 17 further comprising, in response to the input, optimizing content obtained from a content provider, which optimization is based on user input context and content relevance.

30. The method of claim 21 further comprising disambiguating of the said input meaning based on at least one of context of the input content, user location, gender, and input language.

31. The method of claim 17 further comprising:
in response to a result returned from a user input in a first context, receiving an input in an unrelated context, and in response to said unrelated context, temporarily detouring away from the said first context;
returning a result in respect of the said unrelated context; and
reverting back to the said first context;
wherein context comprises the current state of the system.

32. The method of claim 17 further comprising:
in response to the input returning no result, automatically relaxing criteria from the said input to obtain contextually relevant results;
analyzing the input and based on the values input returning active items given the current context of the input criteria.

33. A system comprising a processing unit and memory element, and having instructions encoded thereon, which instructions cause the system to:
receive an input in a context;
return a result in respect of the received context by at least one of narrowing, broadening, and location handling in respect of the input value;
wherein an operation is performed based upon the context of input criteria;
wherein the narrowing further comprises returning a one or more relevant items based on a current result returned in response to the input, and comprising possible criteria values;
wherein the broadening further comprises, when an exact result is not found, broadening the input criteria automatically, and where appropriate, to obtain a result; and
wherein the location handling further comprises disambiguating addresses and locations where there are conflicts based on an input history, and establishing relationships within addresses based upon an input history.

34. A dynamic, self-evolving, computer automated system comprising a processing unit and a memory element, and having instructions encoded thereon which instructions cause the system to:
develop evolving interactive capability without human authoring of scenarios for each user interaction, wherein said evolving further comprises determining a user interaction based on the context and content;
automatically define rules that enhance the automated functionality;
implement natural language processing wherein said natural language processing comprises mapping a user input to meaning, and which mapping further comprises genre tagging;
differentiate between a set which comprises a grouping and a set which comprises the action of making a change; and
create a hierarchical structure for allowing matching of input to at least one of a single or plurality of general ancestors and a single or plurality of descendants.

35. The system of claim 34 wherein the natural language processing further comprises automatic conversion of a string in a natural language to a structured, machine readable format which provides a basis for determining meaning.

36. The system of claim 34 wherein the said genre tagging further comprises:
matching of words and phrases of user input to a normalized semantic form for comparison with content; and
analyzing parts of speech to disambiguate ambiguous input.

37. In a computer automated system comprising a processing unit and a memory element, and having instructions encoded thereon, a method for dynamic self-evolving of the computer automated system, comprising:
developing evolving interactive capability without human authoring of scenarios for each user interaction, wherein said evolving further comprises determining a user interaction based on the context and content;
automatically defining rules to enhance the automated functionality;
implementing natural language processing wherein said natural language processing further comprises mapping a user input to meaning, and which mapping further comprises genre tagging;
differentiating between a set which comprises a grouping and a set which comprises the action of making a change;
creating a hierarchical structure for allowing matching to at least one of a single or plurality of general ancestors or a single or plurality of descendants.

38. The method of claim 37 wherein the natural language processing further comprises automatic conversion of a string in a natural language to a structured, machine readable format which provides a basis for determining meaning.

39. The method of claim 37 wherein the said genre tagging further comprises:
matching of words and phrases of user input to a normalized semantic form for comparison with content; and
analyzing parts of speech to disambiguate ambiguous input.

40. The system of claim 1 wherein the command further comprises the instruction to perform a search or an operation in the input context.
